(19) United States
(12) Patent Application Publication
(10) Pub. No.: US 2008/0212041 A1
(43) Pub. Date: Sep. 4, 2008

(54) Information processing device and projection program

(75) Inventors: Michiaki Koizumi, Osaka (JP); Genji Kohara, Hyogo (JP); Eita Katsu, Osaka (JP)

Correspondence Address: KRATZ, QUINTOS & HANSON, LLP, 1420 K Street, N.W., Suite 400, WASHINGTON, DC, 20005, US

(73) Assignee: SANYO ELECTRIC CO., LTD.,, Moriguchi-shi (JP)

(21) Appl. No.: 12/071,986

(22) Filed: Feb. 28, 2008

(30) Foreign Application Priority Data
Mar. 1, 2007 (JP) 2007-051450

(51) Int. Cl. G03B 21/14; G03B 21/26

(52) U.S. Cl. 353/122; 353/15; 353/70

(57) ABSTRACT

An information processing device including a projection unit which, when a predetermined signal is received while an image displayed on a display is being viewed, projects the image displayed on the display onto, for example, a wall as a substitute for a screen, which is not provided in the information processing device. As the projection unit, for example, a small-sized projector provided in the information processing device may be used. In response to a conventional problem where, when an incoming call is received while a moving image is being displayed, the user cannot view the moving image since the user has to put the mobile phone to an ear for having a conversation, the information processing device causes the projector to project the moving image so that the user can continue to view the image.

### BACKGROUND OF THE INVENTION

(1) Field of the Invention

The present invention relates to an information processing device, and specifically to playback of a moving image during a communication performed by the information processing device.

(2) Description of the Related Art

In recent years, increased number of people have viewed moving images on mobile phones. A problem in such a viewing is that, when the mobile phone receives an incoming signal while the user is viewing a moving image displayed on the display thereof, the mobile phone displays, on the display, information indicating the detection of the incoming signal, instead of the moving image. This prevents the user from viewing the moving image. Also, typically, the user puts the mobile phone to an ear when he/she performs a conversation. This also prevents the user from viewing the moving image since he/she cannot see the display. Also, since the priority is given to the voice of the conversation over the sound of the moving image, the sound of the moving image is not output.

There is known a technology aimed to solve the problem and enable the user to perform a conversation while viewing the moving image. According to this technology, when an incoming signal is received, the input/output of the audio is automatically changed such that the voice of the conversation is output to an external device, such as an earphone, connected to the mobile phone, and the voice of the user is picked up by a microphone connected to the mobile phone.

However, according to this technology, the user is required to carry the earphone and microphone always so that any time the mobile phone receives a conversation request, the user can perform a conversation while viewing the moving image. This impairs the mobility of the mobile phone since the user is required to carry devices such as the earphone and microphone, as well as the mobile phone.

### SUMMARY OF THE INVENTION

According to one aspect of the present invention, for achieving the above object, there is provided an information processing device with a function to transmit and receive signal to/from another device, comprising: a display unit for displaying an image; a projection unit for projecting an image; and a control unit for, when a predetermined signal is received from the other device while the display unit is displaying a first image in accordance with an image data, causing the projection unit to project a second image in accordance with the image data.

In the above recitation, the first image is an image displayed by the display unit, and the second image is an image projected by the projection unit. Also, the other device is present outside the information processing device.

According to another aspect of the present invention, for achieving the above object, there is provided an information processing device with a function to transmit and receive signal to/from another device, comprising: a display unit for displaying an image; a projection unit for projecting an image; and a control unit for, when a predetermined signal is received from the other device while the display unit is displaying a first image in accordance with an image data, and when a predetermined instruction is further detected, causing the projection unit to project a second image in accordance with the image data.

Here, the predetermined instruction is, for example: an instruction for projecting an image, where the instruction is issued by a certain operation of the user; an instruction that is issued when a sensor senses an object; or an instruction regarding the direction of the projection of image.

According to still another aspect of the present invention, for achieving the above object, there is provided A projection program which is read into a computer of an information processing device having a function to transmit and receive signal to/from another device, the projection program indicating a processing procedure comprising the steps of: displaying an image; and projecting an image, wherein a second image is projected in accordance with an image data when a predetermined signal is received from the other device while a first image is being displayed in accordance with the image data.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIGS. 1A and 1B show an outer appearance of a mobile phone 100 in one embodiment of the present invention, FIG. 1A is a front surface view of the mobile phone 100, and FIG. 1B is a side view of the mobile phone 100;

FIG. 2 is a block diagram showing the functional structure of the mobile phone 100;

FIGS. 3A and 3B show a use form of the mobile phone of the present invention, FIG. 3A shows that a moving image is displayed on a display; and FIG. 3B shows that the moving image is projected;

FIG. 4 is a flowchart showing the operation of the mobile phone when it receives an incoming signal while a moving image is being displayed;

FIG. 5 is a flowchart showing the operation of the mobile phone when it projects a moving image;

FIG. 6 is a back surface view of the mobile phone in Embodiment 2;

FIG. 7 shows a use form of the mobile phone in Embodiment 2;

FIG. 8 is a flowchart showing the operation of the mobile phone when it receives a TV phone request while a moving image is being displayed in Embodiment 2; and

FIG. 9 is a flowchart showing the operation of the mobile phone when it receives an incoming signal while a moving image is being displayed in Embodiment 3.

### DESCRIPTION OF THE PREFERRED EMBODIMENT

The following describes a mobile phone as a preferred embodiment of an information processing device of the present invention, with reference to the attached drawings.

### Embodiment 1

### <Structure>

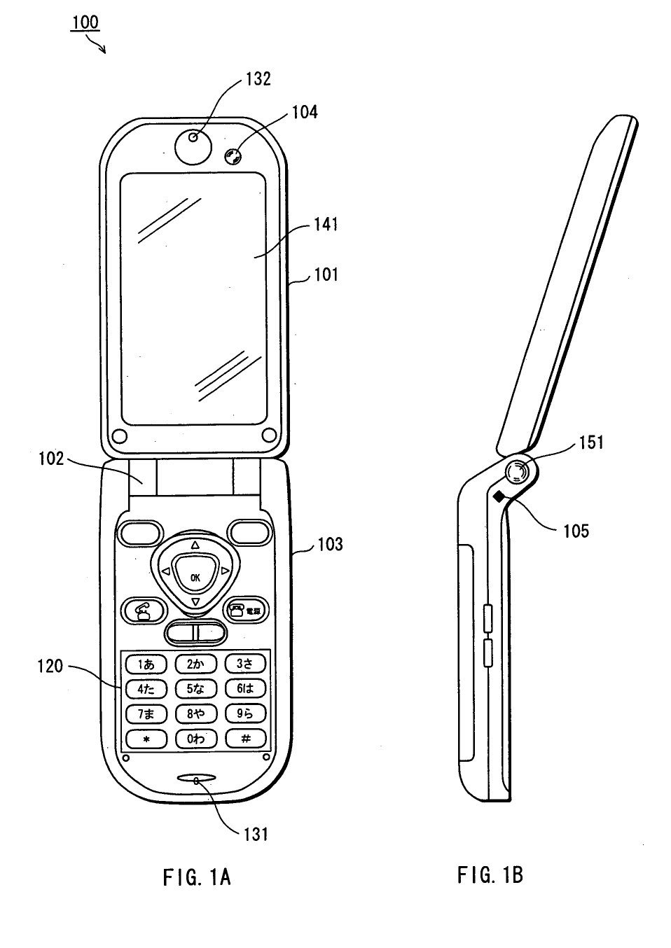

FIGS. 1A and 1B show an example of the outer appearance of a mobile phone 100. In this example, the mobile phone 100 is a folding mobile phone in which an upper member 101 and a lower member 103 are hinged by a hinge 102. FIG. 1A is a front surface view of the mobile phone 100. FIG. 1B is a side view of the mobile phone 100 when viewed from the left-hand side of FIG. 1A.

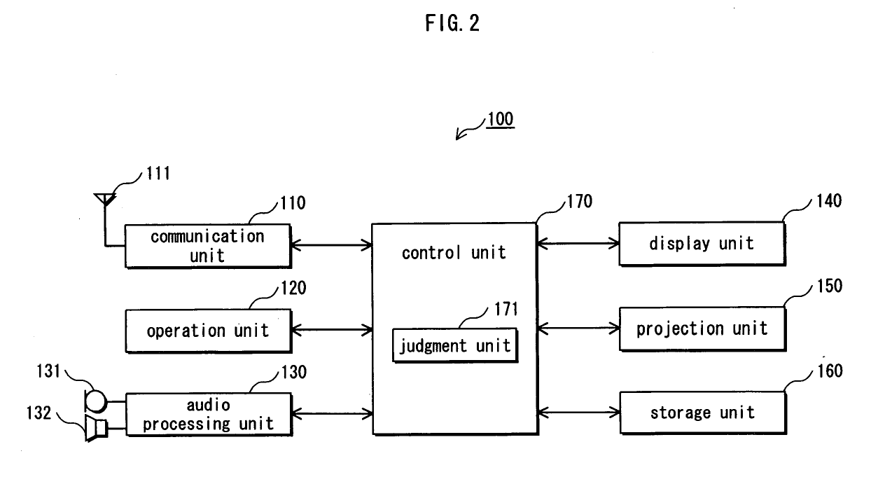

As shown in FIG. 1A, the upper member 101 is provided with a TV-phone-dedicated camera 104, a speaker 132, and a display 141. The lower member 103 is provided with a key group that includes a numeric keypad, direction keys, a determination key and the like. The lower member 103 is also provided with a microphone 131. As shown in FIG. 1B, the side of the hinge 102 is provided with a projector lens 151 for projecting a moving image. Also provided in the vicinity of the projector lens 151 is a human presence sensor 105 for detecting a presence of a human being in the direction in which the moving image is projected by the projector lens 151. In the present document, the human presence sensor 105 is recited merely as “human presence sensor”. However, in the actuality, the human presence sensor 105 may be achieved as an infrared sensor that can detect whether or not there is a human being within a detection range of the sensor by checking whether or not any thing within the range has a temperature that is close to the body temperature of human beings. Alternatively, the human presence sensor 105 may be achieved as a motion sensor that can detect whether or not there is a moving object. FIG. 2 is a block diagram showing the functional structure of the mobile phone 100.

As shown in FIG. 2, the mobile phone 100 includes a communication unit 110, an operation unit 120, an audio processing unit 130, a display unit 140, a projection unit 150, a storage unit 160, and a control unit 170. The above-mentioned first image is an image that is displayed on a display 141 of the display unit 140. The above-mentioned second image is an image that is projected from the projector lens 151 by the projection unit 150. Here, the image displayed or projected at one time may be a still image or a moving image. Namely, the mobile phone 100 can display and project still images and moving images such as TV broadcast images, moving images, streaming images, and photograph images. The first image and the second image are generated based on the same data. In the case where the data is still image data, the first image and the second image are the same image. When the data is moving image data, the first image and the second image may be different images. It should be noted here that the images projected by the projection unit may be projected onto, for example, a wall as a substitute for a screen, which is not provided in the mobile phone 100.

The communication unit 110 includes an antenna 111, and has a function to demodulate a reception signal received with the antenna 111 into a reception audio signal and a reception data signal, and output the reception audio signal and the reception data signal to the audio processing unit 130 and 170, respectively. The communication unit 110 has a function to modulate a transmission audio signal generated by the audio processing unit 130 through an A/D (Analog to Digital) conversion, an output the modulated signal from the antenna 111, and a function to modulate a transmission data signal representing an electronic mail or the like, received from the control unit 170, an output the modulated signal from the antenna 111.

The operation unit 120 includes a key group that includes a numeric keypad, an on hook key, an off hook key, direction keys, a determination key, a mail key and the like. The operation unit 120 has a function to receive an operation of the user, and convey an instruction indicated by the received operation to the control unit 170.

The audio processing unit 130 has a function to perform a D/A (Digital to Analog) conversion onto the reception audio signal output from the communication unit 110, and output the conversion result to the speaker 132, and has a function to perform an A/D conversion onto the transmission audio signal obtained from the microphone 131, and output the conversion result signal to the communication unit 110.

The display unit 140 includes the display 141 that may be achieved by an LCD (Liquid Crystal Display). The display unit 140 has a function to display an image on the display 141 in accordance with an instruction by the control unit 170. More specifically, the display unit 140 displays a standby screen, text of a mail, time or the like. The display unit 140 also displays a moving image onto the display 141 in accordance with an instruction by the control unit 170.

The projection unit 150 has a function to project an image outward in accordance with an instruction by the control unit 170. In recent years, small-sized projectors have been developed. In view of this, a projector is adopted in the present embodiment.

The storage unit 160 includes a ROM (Read Only Memory) and a RAM (Random Access Memory), and may be achieved by a small hard disk, a nonvolatile memory and the like. The storage unit 160 has a function to store music data, image data and the like, as well as various types of data or program required for operating the mobile phone 100.

The control unit 170 has a function to control the other units constituting the mobile phone 100. In the present invention, the control unit 170 includes a judgment unit 171. The judgment unit 171, when the display unit 140 is displaying a moving image onto the display 141, judges whether or not an incoming signal has been received and further judges whether or not a received incoming signal is a conversation request. When the judgment unit 171 judges that a received incoming signal is a conversation request, the control unit 170 causes the projection unit 150 to project the moving image that is currently displayed on the display 141 of the display unit 140.

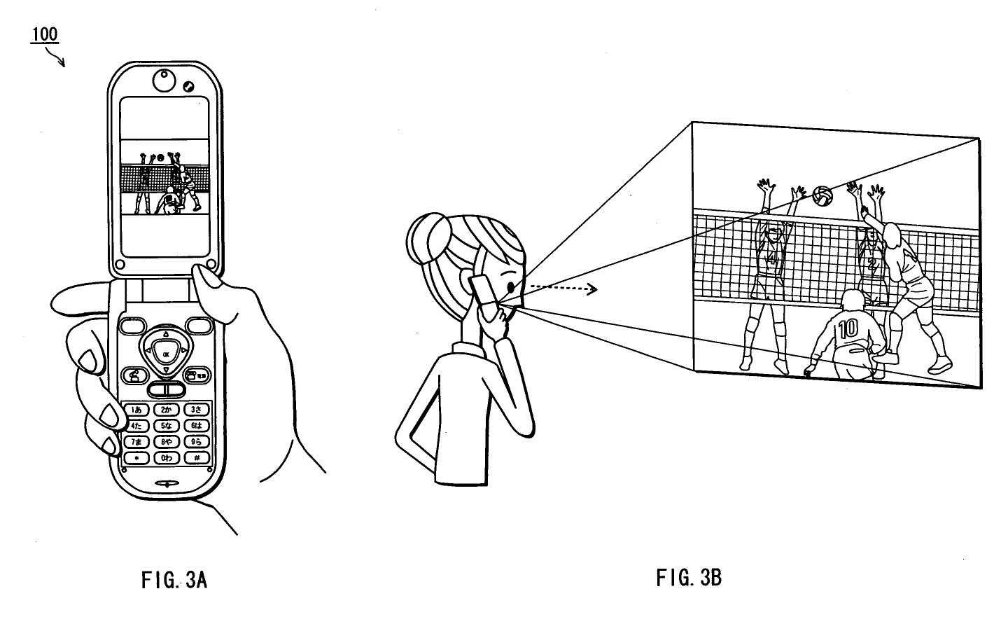

FIGS. 3A and 3B show a use form of the mobile phone 100.

FIG. 3A shows that the user is viewing a moving image displayed on the display 141 of the mobile phone 100. Suppose that the mobile phone 100 receives an incoming signal while the user is viewing the moving image in this way. When the received incoming signal is a conversation request, the mobile phone 100 projects the moving image currently displayed on the display 141, from the projector lens 151, as shown in FIG. 3B, so that the user can have a conversation while viewing the moving image. Since the moving image is projected onto the wall or the like, the user can keep on viewing the moving image without using external equipment such as an earphone or a microphone. It should be noted here that in FIG. 3B, the arrow with a dotted line indicates the line of sight of the user.

### <Operation>

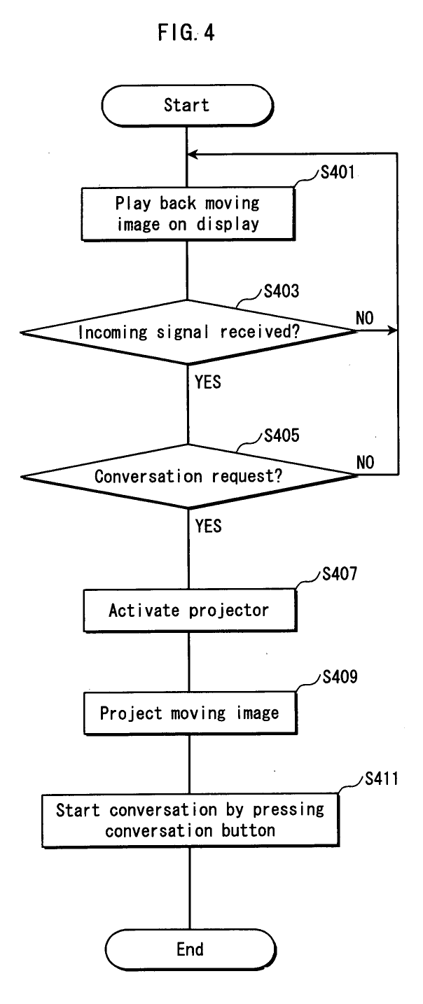

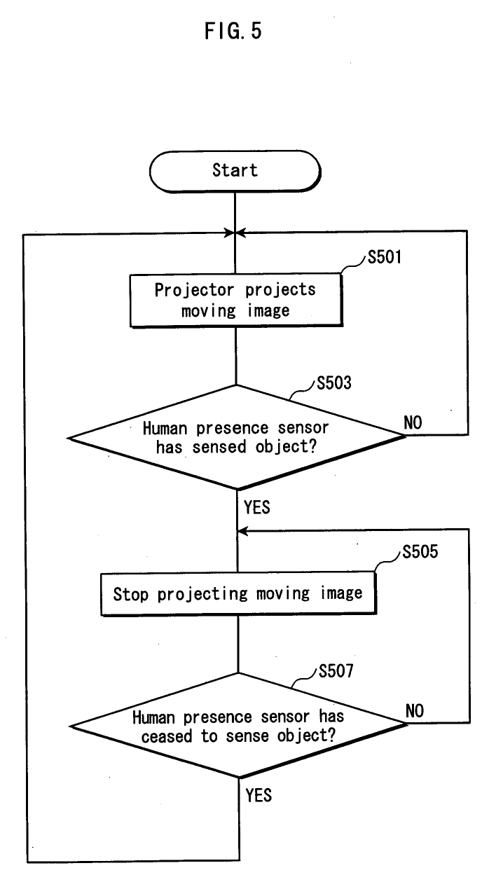

Here, the operation of the mobile phone 100 in the present embodiment will be described with reference to the flowcharts shown in FIGS. 4 and 5.

First, the operation to be performed when the mobile phone 100 receives an incoming signal while the user is viewing a moving image displayed on the display 141 will be described. The mobile phone 100 is playing back and displaying a moving image onto the display 141 (step S401). The control unit 170 judges whether or not an incoming signal has been received via the communication unit 110 (step S403). When it is judged that no incoming signal has been received (NO in step S403), the control unit 170 causes the moving image to be kept displayed on the display 141 (step S401).

When it is judged that an incoming signal has been received (YES in step S403), the control unit 170 stops displaying the moving image onto the display 141, and judges whether or not the received incoming signal is a conversation request (step S405). When it is judged that the received incoming signal is not a conversation request (NO in step S405), the control unit 170 resumes displaying the moving image on the display 141 (step S401). It should be noted here that an incoming signal other than a conversation request is, for example, a mail.

When it is judged that the received incoming signal is a conversation request (YES in step S405), the control unit 170 instructs the projection unit 150 to activate the projector (step S407). After the projector is ready for projection, the control unit 170 causes the projection unit 150 to project the moving image starting with a position at which the playback stopped due to the reception of the incoming signal (step S409). The control unit 170 obtains a playback elapsed time which indicates a time period for which the playback continued until it was stopped due to the reception of the incoming signal. The control unit 170 transfers, to the projection unit 150, the moving image data from a position that corresponds to the obtained playback elapsed time. The conversation is started as the conversation button is pressed (step S411). This ends the process of this flowchart. It should be noted here that the projection of the moving image ends as the conversation ends, and the moving image having been projected is displayed on the display 141.

Next, the operation of the mobile phone 100 during the projection will be described with reference to FIG. 5.

The mobile phone 100 is projecting a moving image outward (step S501). The control unit 170 of the mobile phone 100 judges whether or not the human presence sensor 105 has sensed an object, namely, whether or not the human presence sensor 105 has detected a presence of a human being (step S503). In this judgment, when the human presence sensor 105 is, for example, an infrared sensor, the sensor judges whether or not there is any thing that has a temperature within a predetermined range, namely, a body temperature of a human being.

Unless the human presence sensor 105 senses an object (NO in step S503), the projector of the mobile phone 100 keeps on projecting the moving image. When the human presence sensor 105 has sensed an object (YES in step S503), the control unit 170 of the mobile phone 100 instructs the projection unit 150 to stop the projection. Upon receiving the instruction, the projection unit 150 stops projecting the moving image (step S505). While the projection is stopped, the control unit 170 judges whether or not the human presence sensor 105 has ceased to sense the object (step S507). The control unit 170 keeps on causing the projection unit 150 to stop projecting the moving image unless the human presence sensor 105 ceases to sense the object (step S505).

When the human presence sensor 105 has ceased to sense the object (YES in step 5507), the control unit 170 instructs the projection unit 150 to resume projecting the moving image. Upon receiving the instruction, the projection unit 150 resumes projecting the moving image starting with a position where a presence of a human being was sensed and the projection of the moving image was stopped (step S501).

With this structure, for example, when there is a person in the direction of the projection, the presence of the person is detected, and the projection of the moving image is stopped. The structure thus prevents passersby from being annoyed by the projection when the image is projected outdoors.

Up to now, the operation of the mobile phone 100 in Embodiment 1 has been described. As described above, when a conversation request is received while a moving image is being displayed on the display 141, the moving image being displayed on the display 141 can be projected outward of the device by the projector. This is one of the characteristics of Embodiment 1. Since the mobile phone 100 projects the moving image using the projector that is provided in the device itself, the user needs not carry any equipment such as a microphone or an earphone. Also, even if the user receives a conversation request while he/she is viewing a moving image, the user can keep on viewing the moving image while having a conversation, and thus the user does not fail to view a scene.

### Embodiment 2

In the above-described Embodiment 1, when a phone call is received while a moving image is displayed on the display 141, the moving image is projected. To be described in the present embodiment is an operation to be performed when the mobile phone 100 receives a TV phone call, not a mere phone call, while it is displaying a moving image.

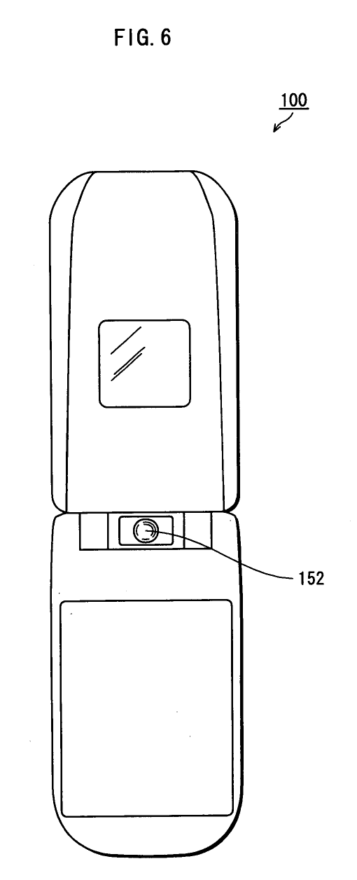

FIG. 6 shows an outer appearance of the mobile phone 100 in Embodiment 2. FIG. 6 is a back surface view of the mobile phone 100, where the front surface view is shown in FIG. 1A. As shown in FIG. 6, the mobile phone 100 is provided with a projector lens 152 at the center of the hinge 102. In the present embodiment, the projection unit 150 includes the projector lens 151 and the projector lens 152. And the mobile phone 100 can project a moving image through the projector lens 152, as well.

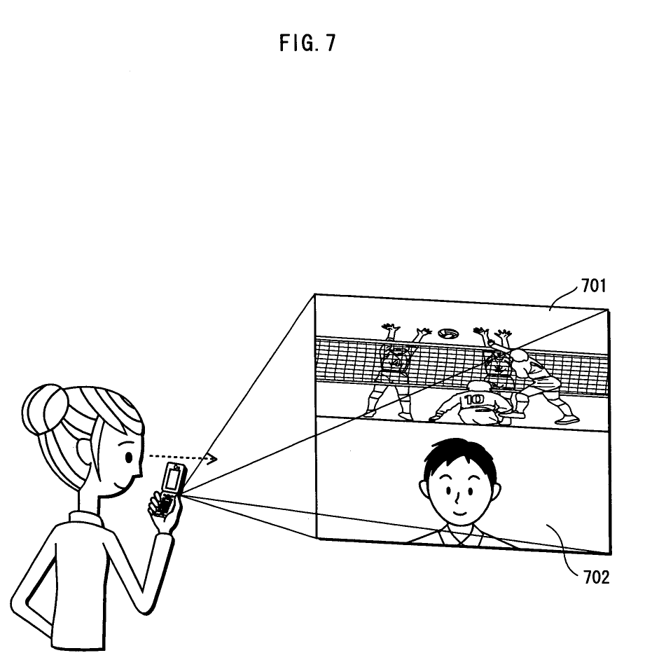

FIG. 7 shows a use form of the mobile phone 100 in Embodiment 2. In Embodiment 2, when the-mobile phone 100 receives a TV phone call while the user is viewing a moving image displayed on the display 141, the mobile phone 100 projects the moving image having been displayed on the display 141 onto a wall or the like in an upper region, which is one of two split regions of the projected screen, and projects the facial image of a person who made the TV phone call, in a lower region of the projected screen, as shown in FIG. 7.

### <Structure>

The functional structure of the mobile phone 100 in Embodiment 2 is almost the same as that of the mobile phone 100 in Embodiment 1. The following shows the structural difference from Embodiment 1, which is required to achieve the operation unique to Embodiment 2.

The judgment unit 171 of the mobile phone 100 has, in addition to the function explained in Embodiment 1, a function to judge whether an incoming signal is a conversation request or a TV phone request. This judgment is made based on information contained in the received signal, where the information indicates whether the signal is a conversation request or a TV phone request.

Also, when a TV phone request is received while a moving image is displayed on the display 141, the control unit 170 transfers, to the projection unit 150, both of two types of data: data of a moving image transmitted from the partner of the TV phone communication; and data of the moving image having been displayed on the display 141. The control unit 170 also has a function to instruct the projection unit 150 to project the two types of moving images.

The projection unit 150 has a function to, based on an instruction from the control unit 170, project the two different moving images through the projector lens 152 respectively into two split regions of the projected screen.

### <Operation>

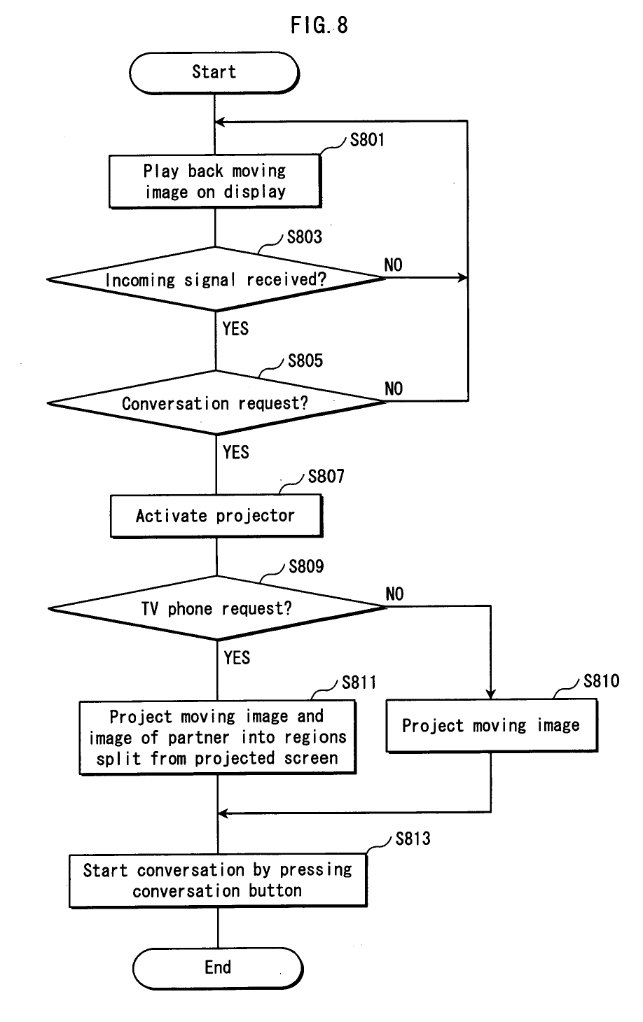

FIG. 8 is a flowchart showing the operation of the mobile phone 100 in Embodiment 2.

As shown in FIG. 8, the mobile phone 100 is playing back and displaying a moving image onto the display 141 (step S801). The control unit 170 judges whether or not an incoming signal has been received via the communication unit 110 (step S803). When it is judged that no incoming signal has been received (NO in step S803), the control unit 170 causes the moving image to be kept displayed on the display 141 (step S801).

When it is judged that an incoming signal has been received (YES in step S803), the control unit 170 stops displaying the moving image onto the display 141, and judges whether or not the received incoming signal is a conversation request (step S805). When it is judged that the received incoming signal is not a conversation request but a mail or the like (NO in step S805), the control unit 170 resumes displaying the moving image on the display 141 (step S801).

When it is judged that the received incoming signal is a conversation request (YES in step S805), the control unit 170 instructs the projection unit 150 to activate the projector (step S807). The judgment unit 171 judges whether or not the conversation request is a TV phone request (step S809). Here, the judgment unit 171 makes the judgment based on a difference in the header of the received signal. When it is judged that the conversation request is not a TV phone request (NO in step S809), the control unit 170 instructs the projection unit 150 to project the moving image having been displayed on the display 141, and the projection unit 150 projects the moving image in accordance with the instruction. In this case, the projection unit 150 projects the moving image through the projector lens 151, for example, as shown in FIG. 3B (step S810).

When it is judged that the conversation request is a TV phone request (YES in step S809), the control unit 170 instructs the projection unit 150 to project both the moving image having been displayed on the display 141 and the moving image of the partner of the TV phone communication. The control unit 170 transfers, to the projection unit 150, data of the moving image of the partner of the TV phone communication and data of the moving image having been displayed on the display 141. The projection unit 150 projects the moving image having been displayed on the display 141 in a moving image region 701, which is an upper region of the projected screen, and projects the moving image of the communication partner that is transmitted from the communication partner, in a partner image region 702 that is a lower region of the projected screen, for example, as shown in FIG. 7, through the projector lens 152 (step S811).

The conversation or the TV phone communication is started as the conversation button is pressed by the user (step S813). This ends the process of this flowchart. It should be noted here that the projection of the moving image(s) ends as the conversation or the TV phone communication ends, and the moving image having been projected in the moving image region 701 is displayed on the display 141.

Up to now, the operation of the mobile phone 100 in Embodiment 2 has been described. As described above, when a TV phone request is received while a moving image is being displayed on the display 141, the moving image transmitted from the partner of the TV phone communication and the moving image having been displayed on the display 141 are projected into two split regions of the projected screen, respectively. This is one of the characteristics of Embodiment 2. This enables the user to view the moving image while checking on the facial expression of partner of the TV phone communication, with ease, eliminating the need of the user to be busy in switching between viewing the partner on the display and viewing the projected moving image.

### Embodiment 3

In the above-described Embodiments 1 and 2, when a phone call or a TV phone call is received while the user is viewing a moving image displayed on the display 141, the mobile phone 100 projects the moving image having been displayed on the display 141. In such a case, when the mobile phone 100 receives a phone call or a TV phone call, the mobile phone 100 displays information indicating reception of the phone call or TV phone call on the display 141, and while the information is displayed on the display 141, the moving image is not displayed on the display 141. Also, it takes time (although it is slight) before a projector has been activated. This causes a time lag to the start of projecting a moving image. In such cases, the user might miss an important scene when the moving image displayed on the display 141 is a TV broadcast image or a streaming image. The present embodiment discloses a technology for avoiding such problems from occurring.

### <Structure>

The functional structure of the mobile phone 100 in Embodiment 3 is almost the same as that of the mobile phone 100 in Embodiment 1. The following will describe only the differences from Embodiment 1, omitting overlapping explanations.

The mobile phone 100 has, in addition to the functions explained in Embodiment 1, a function to receive TV broadcast moving image data or streaming moving image data, via the communication unit 110.

Also, the control unit 170 has, in addition to the functions explained in Embodiment 1, a function to record the received TV broadcast data or streaming data into the storage unit 160. The control unit 170 also has a function to cause the display unit 140 to display, or the projection unit 150 to project, the recorded data in a time-shift playback.

### <Operation>

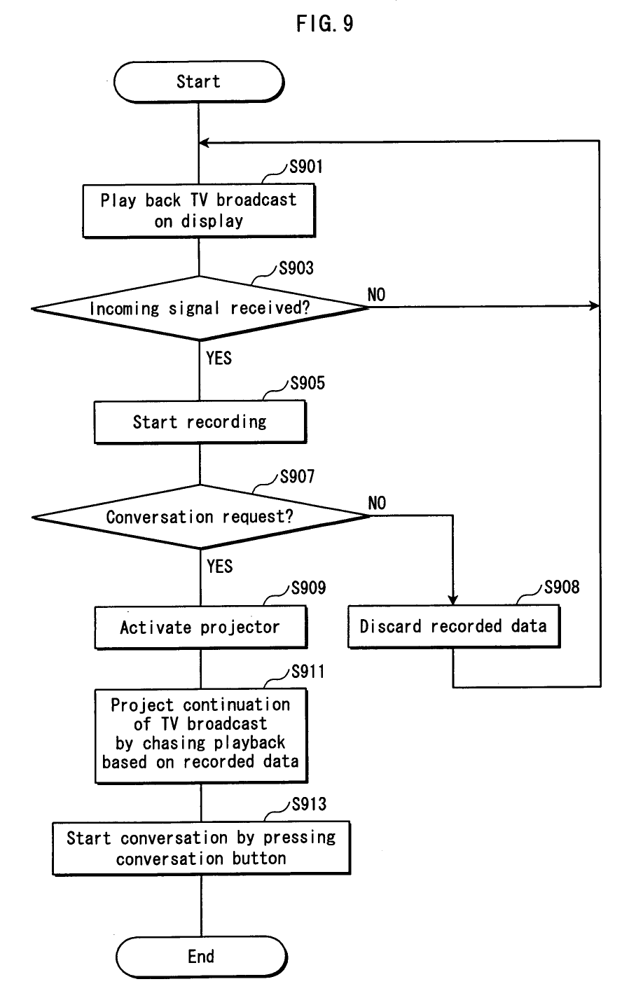

FIG. 9 is a flowchart showing the operation of the mobile phone 100 in Embodiment 3. In the following example, a case where a TV broadcast data is received and played back will be described. However, not limited to this, streaming moving image data or the like may be received and played back instead.

The mobile phone 100 is receiving and playing back TV broadcast data onto the display 141 (step S901). The control unit 170 judges whether or not an incoming signal has been received via the communication unit 110 (step S903). When it is judged that no incoming signal has been received (NO in step S903), the control unit 170 causes the TV broadcast data to be kept displayed on the display 141 (step S901).

When it is judged that an incoming signal has been received (YES in step S903), the control unit 170 stops displaying the TV broadcast data onto the display 141, and starts recording the TV broadcast data (step S905). The control unit 170 then judges whether or not the received incoming signal is a conversation request (step S907). When it is judged that the received incoming signal is not a conversation request (NO -in step S907), the control unit 170 stops recording the TV broadcast data. It should be noted here that an incoming signal other than a conversation request is, for example, a mail. After this, the control unit 170 discards the recorded TV broadcast data (step S908), and resumes playing back the TV broadcast data onto the display 141.

When it is judged that the received incoming signal is a conversation request (YES in step S907), the control unit 170 instructs the projection unit 150 to activate the projector (step S909). After the projector is ready for projection, the control unit 170 causes the projection unit 150 to project the TV broadcast data starting with a position at which the playback stopped due to the reception of the incoming signal (step S911). The conversation is started as the conversation button is pressed (step S913). This ends the process of this flow chart. It should be noted here that the projection of the TV broadcast data ends as the conversation ends, and a continuation of the TV broadcast data having been projected is displayed on the display 141.

Up to now, the operation of the mobile phone 100 in Embodiment 3 has been described. As described above, when a conversation request is received while a moving image of one segment TV broadcast or streaming is being displayed on the display 141, the moving image data can be recorded. This is one of the characteristics of Embodiment 3. With this structure where the received moving image data is recorded, it is possible to prevent the user from missing an important scene due to a time lag that occurs when a display of moving image data is switched to a projection thereof.

### <Supplementary Notes>

Up to now, mobile phones as preferred embodiments of the present invention have been described. However, the present invention is not limited to these embodiments. The following describes some examples of modifications to the embodiments.
(1) The present invention may be methods of projecting a moving image when a conversation request is received while the moving image is being displayed on the display 141, as described above in the embodiments. Also, the present invention may be a computer program which is to be read into a computer provided in the mobile phone 100 to achieve any of the methods.
(2) In the above-described embodiments, the audio was not specifically explained. In this respect, when a moving image is projected, the audio may be output at a reduced level, or may not be output at all. In this case, while the user is viewing the image projected by the mobile phone 100, the sound is not output, or if it is output, only a small amount of sound is output. This prevents the user's conversation from being hampered by the sound of the moving image.
(3) The direction of the projector lens 151, which is provided in the mobile phone 100 described above in each embodiment, differs depending on the use form of the mobile phone 100 by the user when he/she is having a conversation. In view of this, an inclination sensor may be provided in the mobile phone 100 to detect an inclination of the mobile phone 100, and the projection direction may be adjusted based on the inclination of the mobile phone 100 such that, for example, approximately a horizontally long image is always projected. The projectors originally have a function to adjust the projection angle. Therefore, the function may be used to adjust the projection direction so that approximately a horizontally long image is always projected.

Further, when the projector lens is provided in the hinge as is the case with Embodiment 2, the hinge may be provided with a motor such that the motor rotates the projector. With this structure, compared with the case where the projector adjusts the projection angle only by a slight amount, it is possible to adjust the projection angle by a large amount.
(4) The mobile phone 100 may further have a function to control home appliances in the house, namely a function of a remote controller. In addition to this, the mobile phone 100 may further have an illuminance sensor for detecting an illuminance. With this structure, when a detected illuminance exceeds a threshold value, the mobile phone 100 may control the lighting devices in the room so that the room is dark when the moving image is projected. This enables the user to view the projected moving image more clearly.

Alternatively, the mobile phone 100 may not detect the illuminance using an illuminance sensor, but may merely control the lighting devices in the room so that the surrounding environment becomes dark.
(5) Each of the above-described embodiments may be modified so that the control unit 170 judges whether or not there is subtitle data for the moving image to be projected. When it is judged that there is subtitle data, the control unit 170 may cause the projection unit 150 to project the subtitle based on the detected subtitle data, together with the moving image. This facilitates the user to recognize, for example, the conversation of the characters in the movie while the user is viewing the projected moving image with the sound eliminated. As an alternative modification, the subtitle data may be stored in the mobile phone 100 preliminarily, and the control unit 170 may cause the projection unit 150 to project the subtitle based on the preliminarily stored subtitle data.
(6) The mobile phone 100 may have terminals for connecting with external devices such as an earphone. Suppose that the user attaches an earphone to the mobile phone 100 and is listening to the sound of the moving image through the earphone. In such a state, when the mobile phone 100 receives a conversation request, the mobile phone 100 projects outward the moving image that has been displayed on the display 141, and may output the voice of the conversation partner to the earphone, switched from the sound of the moving image. The mobile phone 100 may further output the sound of the moving image via the speaker 132 provided in the mobile phone 100.
(7) In Embodiment 2 described above, the projected screen is split into two regions such that the mobile phone 100 projects the moving image transmitted from the partner of the TV phone communication into a lower region of the projected screen, and projects the moving image having been displayed on the display 141 into an upper region. However, not limited to this, conversely, the mobile phone 100 may project the moving image transmitted from the partner of the TV phone communication into the upper region, and may project the moving image having been displayed on the display 141 into the lower region. Alternatively, the projected screen may be split into two regions: a region on the left-hand side; and a region on the right-hand side. Further, the projected screen may be split into three or more regions such that as many images may be projected respectively into the split regions.

Still further, the projected screen maybe split into three or more regions such that the moving image having been displayed on the display is projected into one of the regions, and the moving image transmitted from the partner of the TV phone communication is projected into one of the remaining regions.
(8) In Embodiment 3 described above, TV broadcast data is received. However, not limited to this, stream data may be received instead to achieve a playback of a moving image based on the streaming. For example, the mobile phone may access a predetermined server, and play back or project a movie by receiving data of the movie sequentially from the server.
(9) In the embodiments described above, one aspect of the present invention is represented by the mobile phone 100. However, the present invention can be applied to any device as far as the device has a function to have a conversation with a partner, a function to transmit and receive mails, and a function to cause a projector to project an image. The present invention may be achieved in, for example, a PDA (Personal Digital Assistant) having a function of a projector and a conversation function.
(10) In the embodiments described above, a moving image is projected. However, not limited to this, a still image may be projected. Examples of such still images to be projected include an image shot by a camera provided in the mobile phone, and an image downloaded from the Internet. In the case where a still image is projected, the image displayed on the display 141 is the same as the projected image.
(11) In the embodiments described above, when a conversation request is received while a moving image is being displayed on the display 141, the moving image is projected, and the display 141 is stopped displaying the moving image. However, not limited to this, the display 141 may be caused to continue to display the moving image.
(12) In the embodiments described above, when a conversation request is received while a moving image is being displayed on the display 141, the moving image is automatically projected. However, not limited to this, the mobile phone may have a structure where the user can set whether or not the moving image is projected.

For example, the user may be able to set, as a piece of menu setting information by using a GUI (Graphical User Interface), ON or OFF with respect to whether a moving image should be projected when a conversation request is received while the moving image is being displayed. Further, the moving image may be projected when a conversation request is received while the moving image is being displayed, only when the setting information has been set to ON.

Alternatively, when a conversation request is received while the moving image is being displayed, a GUI may be displayed to ask the user whether the moving image should be projected. And then the moving image is projected when the user, on the GUI, inputs a selection to do so.
(13) In Embodiment 2 described above, the projected screen is split into two regions such that the mobile phone 100 projects the moving image of the partner of the TV phone communication and the moving image having been displayed on the display 141 into two split regions, respectively. However, not limited to this, when a conversation request is received while the moving image is being displayed, one of the moving image of the partner of the TV phone communication and the moving image having been displayed on the display 141 may be projected, and the other may be displayed on the display 141.
(14) In the embodiments described above, the “recording” means, for example, a recording of an image.
(15) In Embodiment 2 described above, the mobile phone 100 is provided with the projector lens 152, and two different moving images are projected through the projector lens 152 respectively into two split regions of the projected screen. However, not limited to this, the projector lens 152 may not be provided, but two different moving images may be projected through the projector lens 151 respectively into two split regions of the projected screen.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An information processing device with a function to transmit and receive signal to/from another device, comprising:
a display unit for displaying an image;
a projection unit for projecting an image; and
a control unit for, when a predetermined signal is received from the other device while the display unit is displaying a first image in accordance with an image data, causing the projection unit to project a second image in accordance with the image data.

2. The information processing device of claim 1, wherein the predetermined signal is an incoming signal requesting a conversation.

3. The information processing device of claim 1 further comprising:
an audio output unit for outputting audio in accordance with audio data corresponding to the image data, wherein when the control unit causes the projection unit to project the second image, the control unit reduces amount of the audio output by the output unit.

4. The information processing device of claim 1, wherein when there is subtitle data corresponding to the image data, the control unit causes the projection unit to project the second image and a subtitle in accordance with the subtitle data.

5. The information processing device of claim 1 further comprising:
an inclination detecting unit for detecting an inclination of the information processing device, wherein
the control unit controls a projection direction of the second image projected by the projection unit, in accordance with the inclination detected by the inclination detecting unit.

6. The information processing device of claim 1, wherein when the received predetermined signal is a signal requesting a TV phone conversation, the control unit causes the projection unit to project the second image and an image related to a partner of the TV phone conversation respectively into two regions split from a projected screen.

7. The information processing device of claim 1 further comprising:
an image data receiving unit for receiving the image data, wherein
when the predetermined signal is received from the other device while the display unit is displaying the first image in accordance with the image data received by the image data receiving unit, the control unit records the image data received for a period of time from a time when the predetermined signal was received to a time when the projection unit starts projecting the second image.

8. The information processing device of claim 1, wherein
the display unit continues to display the first image when the control unit causes the projection unit to project the second image.

9. The information processing device of claim 1, wherein
the display unit stops or suspends displaying the first image when the control unit causes the projection unit to project the second image.

10. The information processing device of claim 9, wherein
the display unit displays the first image in accordance with the image data when the control unit causes the projection unit to stop projecting the second image.

11. An information processing device with a function to transmit and receive signal to/from another device, comprising:
a display unit for displaying an image;
a projection unit for projecting an image; and
a control unit for, when a predetermined signal is received from the other device while the display unit is displaying a first image in accordance with an image data, and when a predetermined instruction is further detected, causing the projection unit to project a second image in accordance with the image data.

12. The information processing device of claim 11, wherein
the predetermined signal is an incoming signal requesting a conversation.

13. The information processing device of claim 11 further comprising:
an audio output unit for outputting audio in accordance with audio data corresponding to the image data, wherein
when the control unit causes the projection unit to project the second image, the control unit reduces amount of the audio output by the output unit.

14. The information processing device of claim 11, wherein
when there is subtitle data corresponding to the image data, the control unit causes the projection unit to project the second image and a subtitle in accordance with the subtitle data.

15. The information processing device of claim 11, wherein
when the received predetermined signal is a signal requesting a TV phone conversation, the control unit causes the projection unit to project the second image and an image related to a partner of the TV phone conversation respectively into two regions split from a projected screen.

16. The information processing device of claim 11 further comprising:
an image data receiving unit for receiving the image data, wherein
when the predetermined signal is received from the other device while the display unit is displaying the first image in accordance with the image data received by the image data receiving unit, the control unit records the image data received for a period of time from a time when the predetermined signal was received to a time when the projection unit starts projecting the second image.

17. The information processing device of claim 11, wherein
the display unit continues to display the first image when the control unit causes the projection unit to project the second image.

18. The information processing device of claim 11, wherein
the display unit stops or suspends displaying the first image when the control unit causes the projection unit to project the second image.

19. The information processing device of claim 18, wherein
the display unit displays the first image in accordance with the image data when the control unit causes the projection unit to stop projecting the second image.

20. A projection program which is read into a computer of an information processing device having a function to transmit and receive signal to/from another device, the projection program indicating a processing procedure comprising the steps of:
displaying an image; and
projecting an image, wherein
a second image is projected in accordance with an image data when a predetermined signal is received from the other device while a first image is being displayed in accordance with the image data.
